(19) United States
(12) Patent Application Publication
(10) Pub. No.: US 2024/0313449 A1
(43) Pub. Date: Sep. 19, 2024

(54) DEVICE CONNECTOR AND ELECTRICAL DEVICE

(71) Applicant: SUMITOMO WIRING SYSTEMS, LTD., Mie (JP)

(72) Inventors: Takuma HIRAKIMOTO, Mie (JP); Naoya AKIMOTO, Mie (JP); Keiichi YOSHIDA, Mie (JP); Naoki WATANABE, Mie (JP)

(21) Appl. No.: 18/596,099

(22) Filed: Mar. 5, 2024

(30) Foreign Application Priority Data
Mar. 15, 2023 (JP) 2023-040605

(51) Int. Cl. H01R 12/72; H01R 13/74

(52) U.S. Cl. CPC H01R 12/722; H01R 13/74

(57) ABSTRACT

A device connector is to be mounted on a board in an enclosure while being passed through an opening formed in the enclosure, and provided with a terminal, a housing including a housing body for holding an outer connecting portion of the terminal and a mounting piece, and an auxiliary member supported by the housing on a side where a coupling portion and a board-side connecting portion extend. The auxiliary member includes a pair of guide plates for coupling the coupling portion of the terminal. Each of the pair of guide plates has a guide edge for guiding the auxiliary member by contacting an inner surface of the opening. The guide edge is formed at a position for avoiding the contact of the board-side connecting portion and the coupling portion with the inner surface of the opening while being held in contact with the inner surface of the opening.

### CROSS-REFERENCE TO RELATED APPLICATIONS

This application is based on and claims priority from Japanese Patent Application No. 2023-040605, filed on Mar. 15, 2023, with the Japan Patent Office, the disclosure of which is incorporated herein in its entirety by reference.

### TECHNICAL FIELD

The present disclosure relates to a device connector and an electrical device.

### BACKGROUND

Japanese Patent Laid-open Publication No. 2021-005445 discloses a board connector provided with a housing, a terminal fitting held through the housing and including a board connecting portion to be disposed outside the housing and passed through a through hole of a circuit board, and an alignment plate for positioning the board connecting portion passed therethrough toward the circuit board.

### SUMMARY

A connector may be mounted on a board in an enclosure of an electrical device while being passed through an opening formed in the enclosure. In inserting the connector into the opening, it is required to avoid the contact of a terminal fitting and the enclosure.

Accordingly, the present disclosure aims to avoid the contact of a terminal of a device connector and an enclosure in inserting the device connector into an opening of the enclosure.

The present disclosure is directed to a device connector to be mounted on a board in an enclosure while being passed through an opening formed in the enclosure, the device connector being provided with a terminal including an outer connecting portion, a board-side connecting portion extending in a direction intersecting the outer connecting portion and a coupling portion located between the outer connecting portion and the board-side connecting portion, a housing including a housing body for holding the outer connecting portion with the coupling portion and the board-side connecting portion caused to extend outside and a mounting piece projecting around the housing body, and an auxiliary member supported by the housing on a side where the coupling portion and the board-side connecting portion extend, the auxiliary member including a pair of guide plates for covering the coupling portion from both directions intersecting a virtual plane, the outer connecting portion and the board-side connecting portion being passed along the virtual plane, each of the pair of guide plates having a guide edge for guiding the auxiliary member by contacting an inner surface of the opening in inserting the board-side connecting portion and the coupling portion into the opening, and the guide edge being formed at a position for avoiding contact of the board-side connecting portion and the coupling portion with the inner surface of the opening while being held in contact with the inner surface of the opening.

The present disclosure is also directed to an electrical device with the above device connector, the enclosure including the opening and the board accommodated in the enclosure, the mounting piece being fixed to the enclosure with the device connector passed through the opening, and the board-side connecting portion extending from the housing being fixed to the board in the enclosure.

According to the present disclosure, it is possible to avoid the contact of a terminal of a device connector and an enclosure in inserting the device connector into an opening of the enclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram showing an electrical device according to an embodiment.

FIG. 2 is a perspective view showing a device connector.

FIG. 3 is a perspective view showing the device connector.

FIG. 4 is an exploded perspective view of the device connector.

FIG. 5 is an exploded perspective view partially cut away of the device connector.

FIG. 6 is a diagram showing a work example of mounting the device connector on an enclosure.

FIG. 7 is a diagram showing the work example of mounting the device connector on the enclosure.

FIG. 8 is a diagram showing the work example of mounting the device connector on the enclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

The device connector of the present disclosure is as follows.
(1) The device connector is to be mounted on a board in an enclosure while being passed through an opening formed in the enclosure, and provided with a terminal including an outer connecting portion, a board-side connecting portion extending in a direction intersecting the outer connecting portion and a coupling portion located between the outer connecting portion and the board-side connecting portion, a housing including a housing body for holding the outer connecting portion with the coupling portion and the board-side connecting portion caused to extend outside and a mounting piece projecting around the housing body, and an auxiliary member supported by the housing on a side where the coupling portion and the board-side connecting portion extend, the auxiliary member including a pair of guide plates for covering the coupling portion from both directions intersecting a virtual plane, the outer connecting portion and the board-side connecting portion being passed along the virtual plane, each of the pair of guide plates having a guide edge for guiding the auxiliary member by contacting an inner surface of the opening in inserting the board-side connecting portion and the coupling portion into the opening, and the guide edge being formed at a position for avoiding contact of the board-side connecting portion and the coupling portion with the inner surface of the opening while being held in contact with the inner surface of the opening.

According to this device connector, if the auxiliary member is inserted into the opening while the guide edges of the pair of guide plates are held in contact with the inner surface of the opening, the contact of the board-side connecting portion and the coupling portion with the inner surface of the opening is avoided. If the auxiliary member is passed through the opening and the board-side connecting portion is arranged in the enclosure, the board-side connecting portion can be fixed to the board in the enclosure. Thus, the contact of the terminal fixed to the board in the enclosure of the device and the enclosure can be avoided.
(2) In the device connector of (1), the guide edge may be an inclined edge inclined toward a tip side of the board-side connecting portion in extension directions of the coupling portion and the board-side connecting portion with respect to the housing body.

In this case, since the guide edge is an inclined edge, a projection length of the tip of the board-side connecting portion with respect to the guide edge can be reduced. In this way, it becomes difficult for the board-side connecting portion to contact the inner peripheral surface of the opening.
(3) In the device connector of (2), the opening may have a first inner surface part and a second inner surface part facing the first inner surface part across a gap, and a maximum projection length of the board-side connecting portion with respect to the guide edge may be smaller than a distance between the first and second inner surface parts.

In this case, if the auxiliary member is inserted into the opening while the guide edges are held in contact with the first inner surface part, the contact of the board-side connecting portion with the second inner surface part is suppressed.
(4) In the device connector of (2) or (3), a minimum interval between a part extending from the auxiliary member, out of the board-side connecting portion, and the mounting piece in an extension direction of the guide edge may exceed a thickness of an inner peripheral surface of the opening.

According to this device connector, the auxiliary member is inserted into the opening while the guide edges are held in contact with the first inner surface part, and the mounting piece contacts the outer surface of the enclosure around the opening. In this state, the part extending from the auxiliary member, out of the board-side connecting portion, is located inwardly of the inner surface of the enclosure around the opening. Even if the housing is set in a posture to be fixable to the enclosure thereafter, it is difficult for the board-side connecting portion to contact the enclosure.
(5) In the device connector of any one of (1) to (4), the coupling portion may be inclined at an obtuse angle to each of the outer connecting portion and the board-side connecting portion.

In this case, since a projection amount of the coupling portion can be reduced, it becomes difficult for the coupling portion to contact the inner peripheral surface of the opening.
(6) In the device connector of any one of (1) to (5), the auxiliary member may include an alignment plate for holding the board-side connecting portion passed therethrough.

In this way, the board-side connecting portion can be held at a predetermined position by the alignment plate.

Further, the electrical device of the present disclosure is as follows.
(7) The electrical device is provided with the device connector of any one of (1) to (6), the enclosure including the opening and the board accommodated in the enclosure, the mounting piece being fixed to the enclosure with the device connector passed through the opening, and the board-side connecting portion extending from the housing being fixed to the board in the enclosure.

According to this electrical device, it can be made difficult for the terminal to contact the enclosure in inserting the device connector into the opening.

### Details of Embodiment of Present Disclosure

Specific examples of a device connector and an electrical device of the present disclosure are described below with reference to the drawings. Note that the present disclosure is not limited to these illustrations, but is represented by claims and intended to include all changes in the scope of claims and in the meaning and scope of equivalents.

### Embodiment

Hereinafter, a device connector and an electrical device according to an embodiment are described.

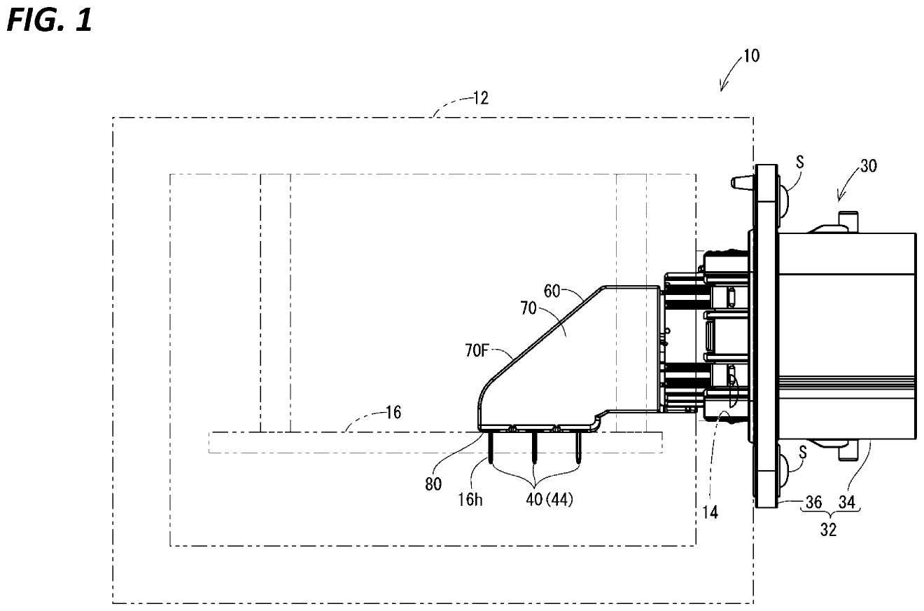

FIG. 1 is a schematic diagram showing an electrical device 10. The electrical device 10 is provided with a device connector 30, an enclosure 12 and a board 16.

The board 16 is formed with a circuit by a copper foil. Mounting components such as a semiconductor chip and a resistor may be mounted on the board 16. The board 16 is formed with through holes 16h.

The enclosure 12 is formed into a box shape to accommodate the board 16. The enclosure 12 is, for example, formed of metal. The enclosure 12 may be formed of resin. The enclosure 12 is formed with an opening 14. The opening 14 is for arranging the device connector 30 passed therethrough. The board 16 may be fixed in the enclosure 12 by screwing or the like.

The device connector 30 is a connector for relaying the circuit of the board 16 and a circuit connected to an external connector. The device connector 30 includes terminals 40, 50, and one end parts of the terminals 40, 50 are held in the device connector 30 and facing the outside of the enclosure 12. By connecting the external connector to the device connector 30, terminals of the external connector are electrically connected to the one end parts of the terminals 40, 50.

The device connector 30 is arranged to pass through the opening 14, whereby the terminals 40, 50 pass between the inside and outside of the enclosure 12. The other ends of the terminals 40, 50 extend toward the inside of the enclosure 12 from the device connector 30. A part of the board 16 is arranged in the opening 14. By connecting the other end parts of the terminals 40, 50 to the through holes 16h formed in the board 16, the other end parts of the terminals 40, 50 are electrically connected to the circuit of the board 16.

The other end parts of the terminals 40, 50 may be soldered in a state connected to the through holes 16h. By press-fitting the other end parts of the terminals 40, 50 into the through holes 16h, the other end parts of the terminals 40, 50 may be pressed against conductors formed on the inner peripheral surfaces of the through holes 16h.

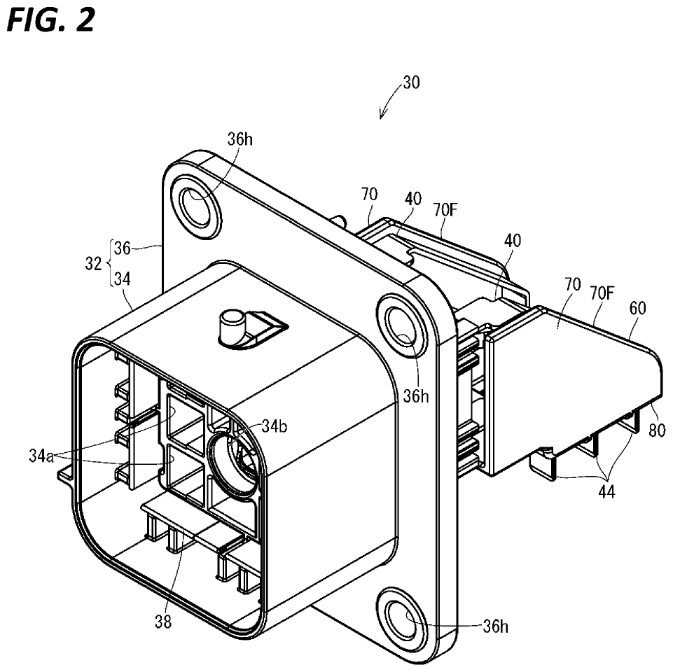

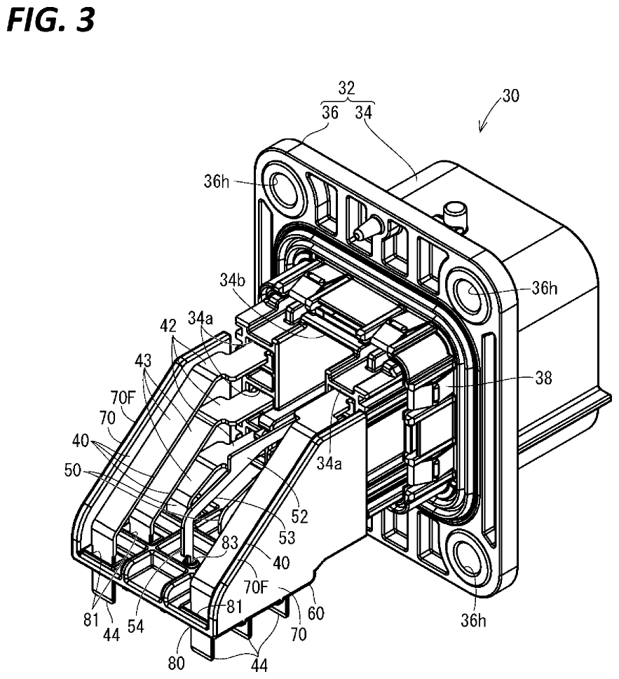

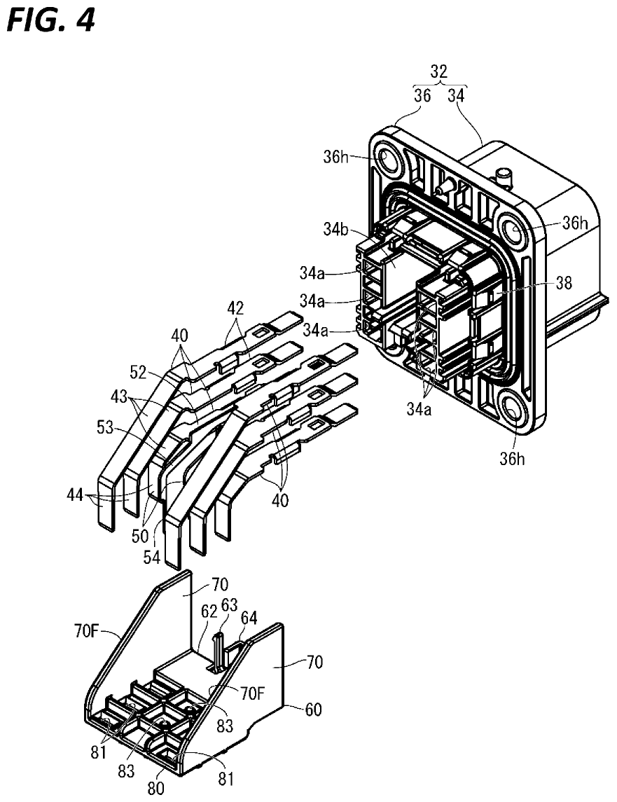

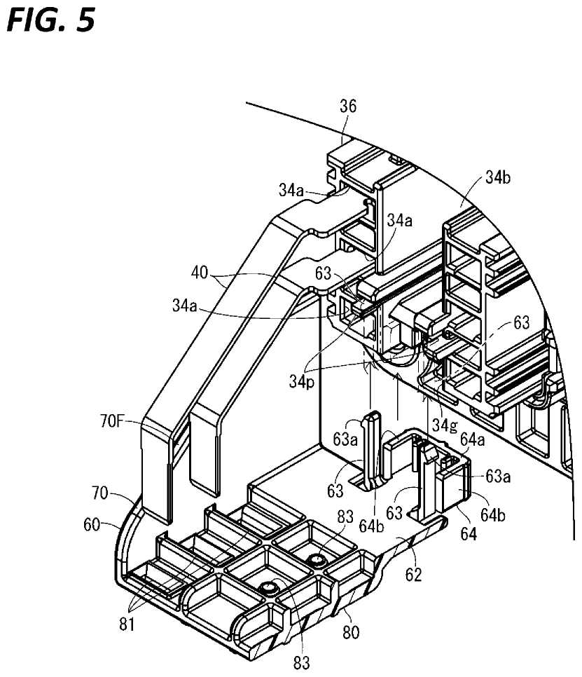

The device connector 30 is more specifically described. FIGS. 2 and 3 are perspective views showing the device connector 30. FIG. 4 is an exploded perspective view of the device connector 30. FIG. 5 is an exploded perspective view partially cut away of the device connector 30. In FIG. 5, the terminals 40, 50 are partially not shown.

The device connector 30 is a connector to be mounted on the board 16 in the enclosure 12 while being passed through the opening 14 of the enclosure 12. The device connector 30 is provided with the terminals 40, 50, a housing 32 and an auxiliary member 60.

The terminal 40 is formed of a conductor such as metal. The terminal 40 is, for example, formed by press-working a metal plate of copper or the like. The terminal 40 may be a terminal for supplying power. For example, a voltage of 10 V or more, a voltage of 20V or more or a voltage of 30 V or more may be applied to the terminal 40.

The terminal 40 includes an outer connecting portion 42, a board-side connecting portion 44 and a coupling portion 43 located between the outer connecting portion 42 and the board-side connecting portion 44.

The outer connecting portion 42 is shaped to extend straight, here in the form of an elongated plate. The outer connecting portion 42 is a part to be accommodated into the housing 32 and connected to the terminal of the mating external connector.

The board-side connecting portion 44 is shaped to extend straight, here in the form of an elongated plate. The board-side connecting portion 44 extends in a direction intersecting the outer connecting portion 42. Here, the board-side connecting portion 44 extends in a direction orthogonal to the outer connecting portion 42. The board-side connecting portion 44 is a part to be fixed to the board 16. Here, the board-side connecting portion 44 is fixed to the board side by being connected to the through hole 16h. Since the board-side connecting portion 44 intersects the outer connecting portion 42, the board-side connecting portion 44 can be inserted into the through hole 16h formed in the board 16 even if the board 16 intersects a part of the enclosure 12 where the opening 14 is formed.

The coupling portion 43 is a part coupling the outer connecting portion 42 and the board-side connecting portion 44 and changing an angle of the board-side connecting portion 44 with respect to the outer connecting portion 42. In this embodiment, the coupling portion 43 is inclined at an obtuse angle to both the outer connecting portion 42 and the board-side connecting portion 44. That is, in an assumed shape in which an outer connecting portion and a board-side connecting portion intersect at a right angle, the coupling portion 43 connects the outer connecting portion and the board-side connecting portion in a short-cut manner before that angle. Thus, an outward projection amount is smaller as compared to the assumed shape in which the outer connecting portion and the board-side connecting portion intersect at a right angle.

In this embodiment, the device connector 30 is provided with a plurality of the terminals 40. More specifically, the device connector 30 is provided with six terminals 40. Three terminals 40 are arranged on one side of the device connector 30, and the remaining three terminals are arranged on the other side of the device connector 30. The respective parts of the respective terminals 40 may differ in length. For example, in the arrangement relationship of the three terminals 40, the terminal 40 located more inside may include the coupling portion 43 having a shorter length.

The terminal 50 is formed of a conductor such as metal. The terminal 50 is, for example, formed by press-working a metal plate of copper or the like. The terminal 50 may be a signal terminal or a terminal for supply lower voltage power than the terminal 40.

The terminal 50 includes an outer connecting portion 52, a board-side connecting portion 54 and a coupling portion 53 located between the outer connecting portion 52 and the board-side connecting portion 54.

The outer connecting portion 52 is a part to be accommodated into the housing 32 in parallel to the outer connecting portions 42 and to be connected to the terminal of the mating external connector.

The board-side connecting portion 54 extends in a direction intersecting the outer connecting portion 52. Here, the board-side connecting portion 54 extends in a direction orthogonal to the outer connecting portion 52. The board-side connecting portion 54 is a part to be fixed to the board 16, similarly to the board-side connecting portion 44, in parallel to the board-side connecting portions 44.

The coupling portion 53 is a part coupling the outer connecting portion 52 and the board-side connecting portion 54 and changing an angle of the board-side connecting portion 54 with respect to the outer connecting portion 52. In this embodiment, the coupling portion 53 is inclined at an obtuse angle to both the outer connecting portion 52 and the board-side connecting portion 54. The coupling portion 53 may or may not be parallel to the coupling portions 43.

In this embodiment, the device connector 30 is provided with a plurality of the terminals 50. More specifically, the device connector 30 is provided with two terminals 50. The two terminals 50 are arranged between the terminals 40 in left and right rows. The respective parts of the respective terminals 50 may differ in length. For example, in the arrangement relationship of the two terminals 50, the terminal 50 located more inside may include the outer connecting portion 52 having a longer length.

The housing 32 is formed of an insulating material such as resin and includes a housing body 34 and a mounting piece 36.

The housing body 34 is formed into a shape to hold the outer connecting portions 42, 52 with the coupling portions 43, 53 and the board-side connecting portions 44, 54 caused to extend outside.

More specifically, the housing body 34 includes cavities 34a for separately accommodating the plurality of outer connecting portions 42. A one-side opening of the cavity 34a is open to the outside of the enclosure 12, and an other-side opening of the cavity 34a is open to the inside of the enclosure 12. A partition may be formed in an intermediate part of the cavity 34a in an extension direction, and the board-side connecting portion 44 may be passed through this partition. In this embodiment, three cavities 34a are arranged in the vertical direction on each of left and right sides of the housing body 32.

The housing 32 includes a cavity 34b for collectively accommodating the plurality of outer connecting portions 52. A one-side opening of the cavity 34b is open to the outside of the enclosure 12, and an other-side opening of the cavity 34b is open to the inside of the enclosure 12. A partition may be formed in an intermediate part of the cavity 34b in an extension direction, and the board-side connecting portions 54 may be passed through this partition. In this embodiment, the cavity 34b is formed in a middle of the housing 32. The plurality of terminals 50 may be supported away from each other by being passed through the partition and held.

The housing 32 is formed to have such an outer shape that the housing 32 can be passed through and arranged in the opening 14 of the enclosure 12.

The mounting piece 36 projects on the periphery of the housing body 34. For example, the mounting piece 36 is in the form of a plate projecting in a direction orthogonal to the extension direction of the cavities 34a, 34b between the both openings of the cavities 34a, 34b in the housing body 34. The mounting piece 36 may be partially formed around the housing body 34 or may be entirely formed. In this embodiment, the mounting piece 36 is in the form of an annular rectangular plate entirely projecting around the housing body 34. In this way, waterproof performance is easily improved between the housing 32 and the enclosure 12.

The mounting piece 36 is formed with screw insertion holes 36h. For example, the screw insertion hole 36h is formed in each of four corner parts of the mounting piece 36.

The mounting piece 36 is formed into a shape expanding larger than the opening 14. With the housing body 34 passed through and arranged in the opening 14, the mounting piece 36 can contact the outer surface of the enclosure 12 around the opening 14. Screw holes are formed at positions of the enclosure 12 corresponding to the screw insertion holes 36 in this state. By screwing screws S into the screw holes of the enclosure 12 through the screw insertion holes 36h, the mounting piece 36 is fixed to the enclosure 12 and, hence, the device connector 30 is fixed to the enclosure 12. In this state, the board-side connecting portions 44, 54 extending from the housing 32 are fixed to the board 16 in the enclosure 12.

The housing 32 may include a shield 38 formed of metal or the like. The shield 38 may be, for example, formed to surround the outer connecting portions 42, 52. If the enclosure 12 is formed of metal, the shield 38 may extend at a position capable of contacting the enclosure 12 on the outer periphery of the housing body 34 or inside the mounting piece 36. In this way, the shield 38 can be grounded via the enclosure 12. Noise shielding performance can be obtained by providing the housing 32 with the shield 38.

The coupling portions 43, 53 extend from a back part of the housing body 34 toward the inside of the housing 12 while being inclined with respect to the outer connecting portions 42, 52. The board-side connecting portions 44, 54 extend in the same direction orthogonal to the outer connecting portions 42, 52 from end parts of the coupling portions 43, 53 on the side of the enclosure 12. In the extension direction of the board-side connecting portions 44, 54, the board-side connecting portions 44, 54 are arranged at the same position and collectively connectable to the board 16.

Further, the plurality of board-side connecting portions 44, 54 are arranged at intervals. Here, on each of the left and right sides, three board-side connecting portions 44 are arranged along the extension direction of the outer connecting portions 42. Further, the two board-side connecting portions 54 are arranged along the extension direction of the outer connecting portions 52 between the board-side connecting portions 44 in the left and right rows.

That is, the six board-side connecting portions 44 are located in both outer columns of 3×3 grid points, and the two board-side connecting portions 54 are located at the positions of the grid points except the one on a side distant from the housing body 34 in a center column of the 3×3 grid points.

The auxiliary member 60 is a member formed of an insulating material such as resin, and supported by the housing 32 on a side where the coupling portions 43, 53 and the board-side connecting portions 44, 54 extend.

The auxiliary member 60 includes a pair of guide plates 70. The pair of guide plates 70 cover the coupling portions 43, 53 from both directions intersecting a virtual plane, along which the outer connecting portions 42, 52 and the board-side connecting portions 44, 54 are passed. In this embodiment, the outer connecting portions 42, 52 and the board-side connecting portions 44, 54 are orthogonal. The pair of guide plates 70 cover the coupling portions 43, 53 from both directions orthogonal to the virtual plane, along which the outer connecting portions 42, 52 and the board-side connecting portions 44, 54 are passed.

When viewed along the extension direction of the outer connecting portions 42, 52, it can be said that the board-side connecting portions 44, 54 are located between the pair of guide plates 70 and the board-side connecting portions 44, 54 extend along the inner surfaces of the pair of guide plates 70.

The coupling portion 43, 53 are located between the pair of guide plates 70. When viewed along a direction connecting the pair of guide plates 70, the coupling portions 43, 53 are arranged at positions hidden behind the guide plates 70. Parts connected to the coupling portions 43, 53, out of the outer connecting portions 42, 52, are also located between the pair of guide plates 70. Thus, in inserting the device connector 30 into the opening 14, the guide plates 70 contact the inner surface of the opening 14 before the coupling portions 43, 53 and the like contact the inner surface of the opening 14. In this way, the contact of the coupling portions 43, 53 with the inner surface of the opening 14 is suppressed and the coupling portions 43, 53 are protected.

Each of the pair of guide plates 70 has a guide edge 70F for guiding the auxiliary member 60. The guide edges 70F are surfaces for guiding the auxiliary member 60 by contacting the inner surface of the opening 14 when the board-side connecting portions 44, 54 and the coupling portions 43, 53 are inserted into the opening 14. The guide edges 70F are formed at positions for avoiding the contact of the board-side connecting portions 44, 54 and the coupling portions 43, 53 with the inner surface of the opening 14 while being held in contact with the inner surface of the opening 14.

More specifically, the guide edges 70F are formed as inclined edges inclined toward tip sides of the board-side connecting portions 44, 54 along the extension directions of the coupling portions 43, 53 and the board-side connecting portions 44, 54 with respect to the housing body 34. When viewed along the direction connecting the pair of guide plates 70, the guide edges 70E may be parallel to the coupling portions 43. Further, when viewed along the direction connecting the pair of guide plates 70, the guide edges 70F may be located outside the longest coupling portions 43.

If the guide edges 70F are inclined edges, projection lengths of the tips of the board-side connecting portions 44, 54 with respect to the guide edges 70F can be reduced. In this way, it becomes difficult for the board-side connecting portions 44, 54 to contact the inner peripheral surface of the opening 14.

In this embodiment, the guide plate 70 has such a plate shape that a rectangular extending part is connected to one side of a right triangular shape and a rectangular extending part is connected to the other side. The rectangular extending part on the one side extends toward the housing body 34 and covers coupled parts of the outer connecting portions 42, 52 and the coupling portions 43, 53. The rectangular extending part on the other side covers parts connected to the coupling portions 43, 53, out of the board-side connecting portions 44, 54.

The auxiliary member 60 is, for example, held on the housing 32 by the following configuration. That is, a fixing intermediate piece 62 extends between edges on the side of the board-side connecting portions 44, 54, out of the rectangular extending parts on the one sides. A pair of locking pieces 63 and a fixing guide piece 64 are provided to project inward from the fixing intermediate piece 62 (see FIG. 5). The pair of locking pieces 63 are formed to have a long shape and locking protrusions 63a are formed on tip parts thereof. The fixing guide piece 64 is formed into such a shape that a pair of side walls 64b extend in a direction orthogonal to an intermediate plate 64a from both side edges of the intermediate plate 64a.

A guide receiving recess 34g, into which the fixing guide piece 64 is fit, is formed in a part projecting toward the enclosure 12, out of the housing body 34. Further, a pair of lock receiving portions 34p, to which the pair of locking pieces 63 are retained and locked, are formed. The pair of locking pieces 63 and the fixing guide piece 64 are pushed toward the guide receiving recess 34g and the pair of lock receiving portions 34p along the extension direction of the board-side connecting portions 44, 54. Then, the fixing guide piece 64 is fit into the guide receiving recess 34g and the pair of locking pieces 64 retain and lock the pair of lock receiving portions 34p, whereby the auxiliary member 60 is fixed to the housing 32.

The structure for fixing the auxiliary member to the housing is not limited to that of the above example. The auxiliary member may be fixed to the housing by fitting parts of the guide plates into recesses of the housing. The auxiliary member may be fixed to the housing by screwing, welding or bonding.

Further, the auxiliary member 60 includes an alignment plate 80 for holding the board-side connecting portions 44, 54 passed therethrough.

The alignment plate 80 is arranged between the pair of guide plates 70. More specifically, the alignment plate 80 is in the form of a plate expanding between the tip edges of the rectangular extending parts on the other sides of the pair of guide plates 70.

In the alignment plate 80, elongated through holes 81 are formed at positions corresponding to the board-side connecting portions 44 and round through holes 83 are formed at positions corresponding to the board-side connecting portions 54. Here, the alignment plate 80 is in the form of a rectangular plate and three through holes 81 are formed side by side in a row on each of both left and right sides. Further, two through holes 83 are formed side by side in a row in a widthwise center of the alignment plate 80.

More specifically, six through holes 81 are located side by side in both outer columns of 3×3 grid points, and the two through holes 83 are located at the positions of two grid points near the housing body 34 in a center column of the 3×3 grid points.

The plurality of board-side connecting portions 44 are respectively passed through and arranged in the through holes 81, and the plurality of board-side connecting portions 54 are respectively passed through and arranged in the through holes 83. In this way, the plurality of board-side connecting portions 44 and the plurality of board-side connecting portions 54 are easily kept in a predetermined array state, and easily collectively inserted into the through holes 16h formed in the board 16.

Tip parts of the board-side connecting portions 44 and the board-side connecting portions 54 project from the alignment plate 80 and are located outside the pair of guide plates 70. Thus, in inserting the device connector 30 into the opening 14, the tip parts of the board-side connecting portions 44 and the board-side connecting portions 54 are desirably prevented from contacting the opening 14.

A work example of inserting the device connector 30 into the opening 14 is described.

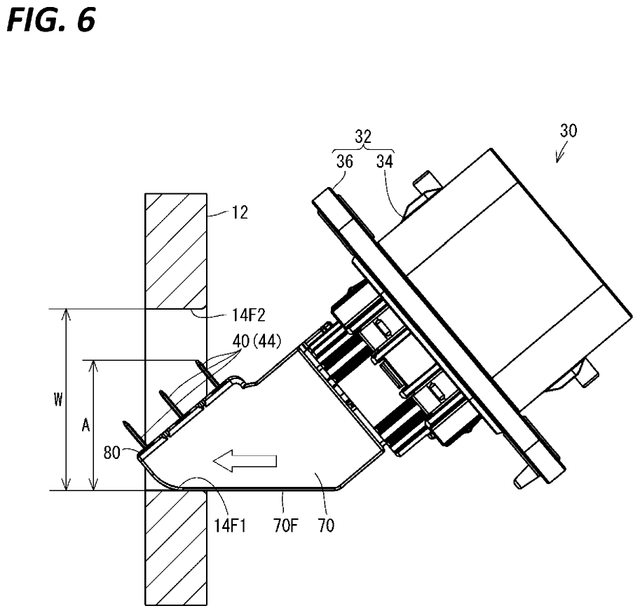

It is assumed that the opening 14 has a first inner surface part 14F1 and a second inner surface part 14F2 facing the first inner surface part 14F1 across a gap as shown in FIG. 6. An interval enabling the arrangement of the housing body 34 is provided between the first and second inner surface parts 14F1, 14F2. It is assumed that the first and second inner surface parts 14F1, 14F2 have a flat surface part.

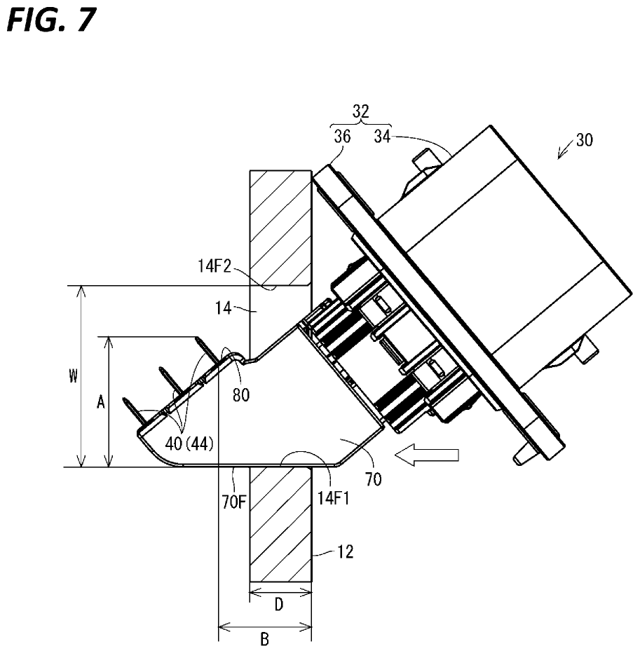

In fixing the device connector 30 to the enclosure 12, the board-side connecting portions 44, 54, the coupling portions 43, 53 and the auxiliary member 60 are first inserted into the opening 14 as shown in FIG. 6. At this time, the respective guide edges 70F of the pair of guide plates 70 are pressed against the first inner surface part 14F1. At this time, the guide edges 70F are so pressed against the first inner surface part 14F1 that an extension direction of the guide edges 70F is along the first inner surface part 14F1. As shown in FIG. 7, the device connector 30 continues to be pushed toward the enclosure 12.

By pressing the guide edges 70F against the first inner surface part 14F1, the device connector 30 is inserted into the opening 14 with the guide edges 70F and the first inner surface part 14F1 kept in parallel. Thus, parts of the board-side connecting portions 44, 54 projecting from the alignment plate 80 can pass through the opening 14 at stable positions. Thus, it is difficult for the board-side connecting portions 44, 54 to contact the opening 14.

Here, it is assumed that W denotes a distance between the first and second inner surface parts 14F1, 14F2. A maximum projection length A of the board-side connecting portions 44, 54 with respect to the guide edges 70F is preferably smaller than the distance W. The maximum projection length A of the board-side connecting portions 44 with respect to the guide edges 70F is the maximum projection length of the board-side connecting portions 44, 54 with respect to a virtual plane, along which the two guide edges 70F passes, in a direction orthogonal to the virtual plane. If one board-side connecting portion 44, 54 is focused, the tip part of the board-side connecting portion 44, 54 is a most projecting part. In the relationship of the plurality of board-side connecting portions 44, 54, if the projection lengths of the board-side connecting portions 44, 54 from the alignment plate 80 are assumed to be equal, the projection length of the board-side connecting portion 44, 54 closest to the housing body 34, out of the plurality of board-side connecting portions 44, 54, is the maximum projection length.

By setting the maximum projection length A smaller than the distance W, the contact of the board-side connecting portions 44, 54 with the second inner surface part 14F2 is more reliably suppressed.

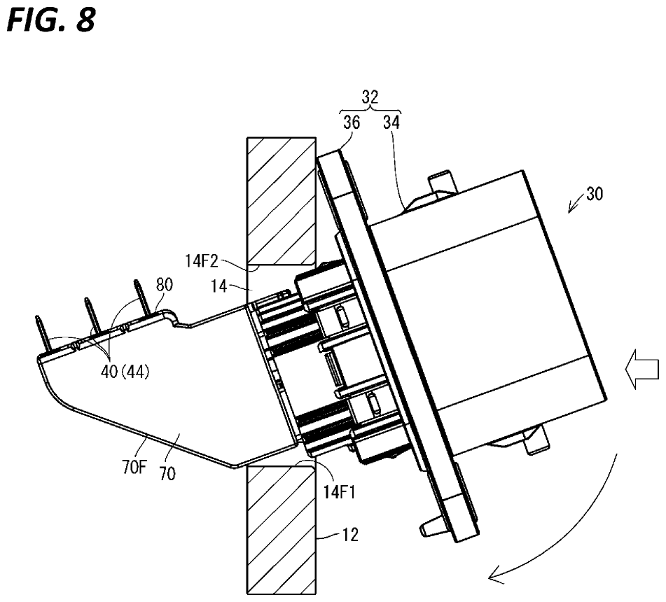

If the board-side connecting portions 44, 54, the coupling portions 43, 53 and the auxiliary member 60 are inserted into the opening 14, the mounting piece 36 eventually contacts the outer surface of the enclosure 12 as shown in FIG. 7. If the device connector 30 continues to be pushed into the enclosure 12, the device connector 30 rotates about a contact position of the mounting piece 36 and the enclosure 12 as shown in FIG. 8.

At this time, to make it difficult for the board-side connecting portions 44, 54 to contact the opening 14, parts extending from the auxiliary member 60, out of the board-side connecting portions 44, 54, preferably enter the enclosure 12 through the opening 14.

To that end, a minimum interval B between the parts extending from the auxiliary member 60 (here, alignment plate 80), out of the board-side connecting portions 44, 54, and the mounting piece 36 may exceed a thickness D of the inner peripheral surface of the opening 14. Note that, if one board-side connecting portion 44, 54 is focused, the minimum interval B is an interval between the base end of the part projecting from the alignment plate 80, out of the board-side connecting portion 44, 54, and a surface of the mounting piece 36 on the side of the enclosure 12. Further, in the relationship of the plurality of board-side connecting portions 44, 54, the minimum interval B is an interval between the board-side connecting portion closest to the housing body 34, out of the plurality of board-side connecting portions 44, 45, and the surface of the mounting piece 36 on the side of the enclosure 12.

If the device connector 30 rotates about the contact position of the mounting piece 36 and the enclosure 12, the mounting piece 36 comes into contact with the outer surface of the enclosure 12 around the opening 14. In this state, the mounting piece 36 is fixed to the enclosure 12 using the screws S, whereby the device connector 30 is fixed to the enclosure 12.

The board-side connecting portions 44, 54 may be fixed to the board 16 before or after the device connector 30 is fixed to the enclosure 12.

According to the device connector 30 and the electrical device 10 configured as just described, if the auxiliary member 60 is inserted into the opening 14 while the guide edges 70F of the pair of guide plates 70 are held in contact with the inner surface of the opening 14, the contact of the board-side connecting portions 44, 54 and the coupling portions 43, 53 with the inner surface of the opening 14 is avoided. If the auxiliary member 60 is passed through the opening 14 and the board-side connecting portions 44, 54 are arranged in the enclosure 12, the board-side connecting portions 44, 54 can be fixed to the board 16 in the enclosure 12. Thus, the device connector 30 can be assembled with the device 10 while avoiding the contact of the terminals 40 to be fixed to the board 16 in the enclosure 12 of the device 10 and the enclosure 12.

Further, since the guide edges 70F are inclined edges inclined with respect to the board-side connecting portions 44, 54, the projection lengths of the board-side connecting portions 44, 54 with respect to the guide edges 70F can be reduced. In this way, it becomes difficult for the board-side connecting portions 44, 54 to contact the inner surface of the opening 14 with the guide edges 70F held in contact with the inner surface of the opening 14.

Further, the maximum projection length A of the board-side connecting portions 44 with respect to the guide edges 70F is smaller than the distance W between the first and second inner surface parts 14F1, 14F2. Thus, the contact of the board-side connecting portions 44, 54 with the second inner surface part 14F2 is suppressed with the auxiliary member 60 inserted in the opening 14 and the guide edges 70F held in contact with the first inner surface part 14F1.

Further, in the extension direction of the guide edges 70F, the minimum interval B between the parts extending from the auxiliary member 60, out of the board-side connecting portions 44, 54, and the mounting piece 36 exceeds the thickness D of the inner peripheral surface of the opening 14. If the auxiliary member 60 is inserted into the opening 14 while the guide edges 70F are held in contact with the first inner surface part 14F1, it is supposed that the mounting piece 36 contacts the outer surface of the enclosure 12 around the opening 14. If the minimum interval B exceeds the thickness D, the parts extending from the auxiliary member 60, out of the board-side connecting portions 44, 54, are located inwardly of the inner surface of the enclosure 12 with the mounting piece 36 held in contact with the outer surface of the enclosure 12. Even if the housing 32 is set in a posture to be fixable to the enclosure 12 thereafter, it is difficult for the board-side connecting portions 44, 54 to contact the enclosure 12.

Further, since the coupling portion 43, 53 is inclined at an obtuse angle to each of the outer connecting portion 42, 52 and the board-side connecting portion 44, 54, the projection amount of the coupling portion 43, 53 can be reduced and it becomes difficult for the coupling portion 43, 53 to contact the inner peripheral surface of the opening 14.

Further, since the auxiliary member 60 includes the alignment plate 80 for holding the board-side connecting portions 44, 54 passed therethrough, the board-side connecting portions 44, 45 can be held at predetermined positions by this alignment plate 80. In this way, the board-side connecting portions 44, 54 are easily inserted into the through holes 16h of the board 16.

Further, according to this electrical device 10, the terminals 40 can be made difficult to contact the enclosure 12 in inserting the device connector 30 into the opening 14.

In this embodiment, the numbers and arrays of the terminals 40, 50 are arbitrary. The device connector 30 may be provided with at least one of the terminals 40 and 50.

Note that the respective configurations described in the above embodiment and modifications can be combined as appropriate as long as these do not contradict each other.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

1. A device connector to be mounted on a board in an enclosure while being passed through an opening formed in the enclosure, comprising:
a terminal including an outer connecting portion, a board-side connecting portion extending in a direction intersecting the outer connecting portion and a coupling portion located between the outer connecting portion and the board-side connecting portion;
a housing including a housing body for holding the outer connecting portion with the coupling portion and the board-side connecting portion caused to extend outside and a mounting piece projecting around the housing body; and
an auxiliary member supported by the housing on a side where the coupling portion and the board-side connecting portion extend,
the auxiliary member including a pair of guide plates for covering the coupling portion from both directions intersecting a virtual plane, the outer connecting portion and the board-side connecting portion being passed along the virtual plane,
each of the pair of guide plates having a guide edge for guiding the auxiliary member by contacting an inner surface of the opening in inserting the board-side connecting portion and the coupling portion into the opening, and
the guide edge being formed at a position for avoiding contact of the board-side connecting portion and the coupling portion with the inner surface of the opening while being held in contact with the inner surface of the opening.

2. The device connector of claim 1, wherein the guide edge is an inclined edge inclined toward a tip side of the board-side connecting portion in extension directions of the coupling portion and the board-side connecting portion with respect to the housing body.

3. The device connector of claim 2, wherein:
the opening has a first inner surface part and a second inner surface part facing the first inner surface part across a gap, and
a maximum projection length of the board-side connecting portion with respect to the guide edge is smaller than a distance between the first and second inner surface parts.

4. The device connector of claim 2, wherein a minimum interval between a part extending from the auxiliary member, out of the board-side connecting portion, and the mounting piece in an extension direction of the guide edge exceeds a thickness of an inner peripheral surface of the opening.

5. The device connector of claim 1, wherein the coupling portion is inclined at an obtuse angle to each of the outer connecting portion and the board-side connecting portion.

6. The device connector of claim 1, wherein the auxiliary member includes an alignment plate for holding the board-side connecting portion passed therethrough.

7. An electrical device, comprising:
the device connector of claim 1;
the enclosure including the opening; and
the board accommodated in the enclosure,
the mounting piece being fixed to the enclosure with the device connector passed through the opening, and
the board-side connecting portion extending from the housing being fixed to the board in the enclosure.
